(19) United States
(12) Patent Application Publication
(10) Pub. No.: US 2026/0126161 A1
(43) Pub. Date: May 7, 2026

(54) Vehicle Light with Heating Element.

(71) Applicant: Wheel Pros, LLC, Greenwood Village, CO (US)

(72) Inventors: Yoshitaka Ishida, Lancaster, CA (US); Chen Yu, Hong Kong (HK); Matt Kossoff, Atlanta, GA (US)

(73) Assignee: Wheel Pros, LLC, Greenwood Village, CO (US)

(21) Appl. No.: 19/357,479

(22) Filed: Oct. 14, 2025

Related U.S. Application Data
(63) Continuation-in-part of application No. 18/940,157, filed on Nov. 7, 2024.

(51) Int. Cl. F21S 45/60

(52) U.S. Cl. CPC F21S 45/60

(57) ABSTRACT

A vehicle light or components design that recycles waste heat from the light source and has an additional heating element attached to radiator vents that creates and distributes heated air inside the vehicle light. This is an optically neutral and energy-efficient lens heating system that prevents snow buildup on the outside of the light in cold and wet weather, allowing for more efficient and therefore safer lights for vehicles. As each ceramic heating element receives electricity from the vehicle, its surface heats up. Blower fans harvest and blow the waste warm air past the heating elements through the radiator vent. It becomes hot air. A temperature sensor regulates the amount of additional electricity that is sent to each ceramic element. An overheat protection sensor measures the radiator temperature to ensure material thermal safety, and an ambient temperature sensor measures the outside temperature to determine when the system should be activated.

### CROSS REFERENCE TO RELATED APPLICATIONS

This utility patent application claims priority back to U.S. Utility patent Ser. No. 18/940,157, filed Nov. 7, 2024, the contents of which are incorporated by reference into this application.

### FIELD OF THE INVENTION

This disclosure is directed generally to Vehicle Lights, and more specifically to a vehicle light with a waste heat recycling design that prevents snow or ice build-up on the front lens cover.

### SUMMARY OF THE INVENTION

A vehicle light or the components design that recycles waste heat from the light source and has an additional heating element attached to a radiator vent that creates and distributes heated air inside the vehicle light. This is an optically neutral and energy-efficient lens heating system that prevents snow buildup on the outside of the light in cold and wet weather, allowing for more efficient and therefore safer lights for vehicles. As each ceramic heating element receives electricity from the vehicle, its surface heats up. Blower fans harvest and blow the waste warm air past the heating elements through the radiator vent. It becomes hot air. A temperature sensor regulates the amount of additional electricity that is sent to each ceramic element. An overheat protection sensor measures the radiator temperature to ensure material thermal safety, and an ambient temperature sensor measures the outside temperature to determine when the system should be activated.

### BACKGROUND OF THE INVENTION

A common problem with an increasing number of modern vehicle lights that use more energy-efficient LED(Light Emitting Diode) as their light source is that when the surrounding air is cold and/or humid, the exterior of the light gets covered with a layer of snow and/or ice build up on the outside of the light, it cannot sufficiently retain the lamp's lens surface temperature high enough to break the adhesion of the snow and/or ice layers because of the high efficiency of power to optical output ratio benefit. This prevents the intended road illuminating low beam projection from efficiently passing through the lamp's lens without being disturbed, resulting in inadequate illumination capability. As such, it is obviously desirable to have a vehicle light that generates enough internal heat so that its lens does not become covered by a layer of snow or ice.

There have been various attempts to make vehicle light lenses heated by embedding, printing, or laminating electrically conductive high thermal resistance materials, such as the resist line typically seen on many vehicles'rear window defogger line grid. Some newer inventions use transparent carbon nanotube heating film. However, neither of the solutions offers an optical neutral result, as the resist line grid must be densely laid out, and it is an opaque material that does not allow light to pass through. Even with the transparent carbon nanotube heating film, there is optical loss due to the material's internal transmittance loss and additional Fresnel loss caused by having another layer on the inner surface of the vehicle's light lens. There is also a concern about film delamination, and the assembly complexity challenge of the electrical line must be addressed with assembly tolerance length.

This invention solves the need for a lens heating function without any degree of optical loss by harvesting waste heat generated by LEDs and providing a vehicle light that has built into it a heating element and a radiator vent, where heated air is directed toward the front of the light by the radiator vents that hold additional heating elements. Essentially, these lights recycle harvested waste heat from the LEDs and produce the additional heat needed to prevent snow and ice from accumulating on the lens of the light, particularly on the inner surface of the lens, thereby preventing optical disturbance through convection heating.

Air from the LED is directed away from the LED by a main optic's cooling fan, and a blower fan harvests the waste heat energy absorbed by the heated air, directing it through a series of ceramic heaters to combine with additional heating power required. When a temperature sensor, called an ambient temperature sensor, located outside the light but electronically connected to a control module inside, detects low temperatures, it determines whether to allow the control module to be activated. The goal sensor, located near the vehicle's front lens inner surface, monitors the heated air convection temperature to determine the required amount of additional heating power and sends the calculated electrical energy to a series of ceramic heating elements arrayed in front of individual spines of the radiator vent. As the ceramic heating elements heat up, the blower fans direct a stream of air that harvests the waste heat from the LEDs past the heating elements to combine additional heat power required. The radiator directs this stream of air vent directly toward the inside of the front surface of the vehicle light, thereby heating it and breaking the adhesion of the snow or ice layer on the outer surface of the light. A goal monitor sensor measures the target surface area convection temperature, and when a desired temperature is reached, it directs the control module to turn off the ceramic heaters. An overheat protection sensor, mounted directly to the radiator, detects excessively high temperatures and directs the control module to turn off the ceramic heaters, ensuring the thermal stability of construction components. The ceramic heaters are also designed not to turn on if any of the convection-creating cooling fans or blower fans are experiencing failure or malfunction, to prevent overheating.

The internal components of the light have several embodiments. In a first embodiment, the main optic's cooling fan blows or pulls air between the heatsink fin that mounts the LED, which requires heat management. The air exchanges waste heat from the LEDs via the heatsink fin surface, which becomes waste heat that warms the air. The blower fan draws in the heat exhaust from the main optics and directs it over the radiator, which mounts a series of ceramic heaters. In a second embodiment, an exhaust heated air guide funnels the air from the main optic's heat exhaust. It directs it into the blower fan, which then has an air guide funnel that directs the air from the blower fan through an air-tight joint duct, which ensures that all the heat exhaust from the main optic cooling fan ends up being blown through the radiator that mounts a series of ceramic heaters. In a third embodiment, a secondary optical unit features a second LED that requires thermal management and is mounted on an air guide/heatsink made of a highly thermally conductive material, such as aluminum, which serves as a heatsink for the second LED. As the waste heat from the main LEDs passes through the air duct/heatsink, the air guide pulls the waste heat from the second LED and passes it to the passing waste heat airflow from the main LED, efficiently adding the second LED's waste heat as available lens heating power. The air from the blower fan runs through an air-tight joint duct, which ensures that all the heat exhaust from the main optic cooling fan ends up being blown through the radiator that mounts a series of ceramic heaters.

This has been outlined, rather broadly, the more important features of the invention so that the detailed description thereof may be better understood, and in order that the present contribution to the art may be better appreciated. There are additional features of the invention that will be described hereinafter, and which will form the subject matter of the claims appended hereto. The features listed herein, and other features, aspects, and advantages of the present invention, will become better understood with reference to the following description and appended claims. The accompanying drawings, which are incorporated in and constitute part of this specification, illustrate embodiments of the invention and, together with the description, serve to explain the principles of the invention.

It should be understood that while the preferred embodiments of the invention are described in some detail herein, the present disclosure is made by way of example only, and that variations and changes thereto are possible without departing from the subject matter coming within the scope of the following claims, and a reasonable equivalency thereof, which claims I regard as my invention.

### BRIEF DESCRIPTION OF THE DRAWINGS

FIG. 1 is a side, cut-away view of a first embodiment of the invention.

FIG. 2 is a side, cut-away view of a second embodiment of the invention.

FIG. 3 is a side, cut-away view of a third embodiment of the invention.

### DETAILED DESCRIPTION OF THE DRAWINGS

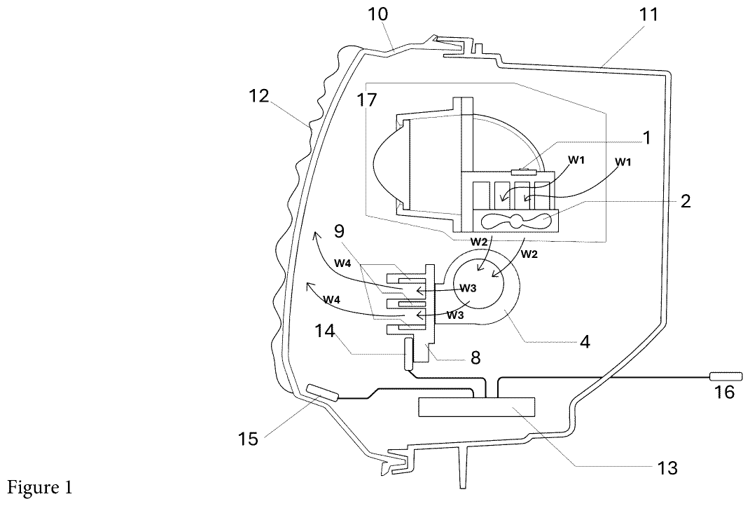

FIG. 1 is a side, cut-away view of a first embodiment of the invention. The main optics cooling fan(2), also called the main optics blower fan, blows or pulls the cool air (W1) in between the heatsink fin that mounts the LEDs(1), also called the main optics, which needs heat management. The passing air flow (W1) created by the cooling fan (2) exchanges to receive the waste heat from the LEDs(1) via the heatsink fin surface, which becomes warm heat exhaust(W2). The blower fan(4) harvests the heat exhaust(W2) from the main optics and directs airflow(W3) over the radiator(8) that mounts a series of ceramic heaters (9) to create adequate total heat power combined with hot air(W4). It should be noted that heaters other than ceramic heaters could be used, and that ceramic heaters are used in this figure for purposes of illustration. As mentioned previously, at certain outside temperatures, the heat from the LED is not sufficient to warm the outer surface of the light lens enough to break the adhesion of the snow or ice layer(12) that has accumulated on the outer surface of the front lens(10) of the light, which strongly disturbs the headlight performance. An ambient temperature sensor (16) located outside the light housing (11) but electronically connected to a control module (13) inside the light detects pre-configured low temperatures to determine whether to activate the control module. The goal sensor (15) that is located near the vehicle light's front lens inner surface monitors the heated air convection(W4) temperature to determine the required amount of additional heating power and sends calculated electrical energy to a series of ceramic heating elements (9) that are arrayed in front of individual spines of the radiator vent(8). The heat from the ceramic heater (9) is dissipated through a radiator (8) with spines. Initially, harvested waste heat (W1) is converted into hot air (W4), which has sufficient heating power, and is projected towards the lens (10) inner surface, located in front of the main optics (17). Hot air (W4) warms the target area of the lens sufficiently to clear/melt away snow or ice (12) that has accumulated. A goal monitor sensor (15) observes the hot air (w4) convection temperature, and when a certain calculated temperature is reached, it sends an electronic message to the control module (13) to turn off the ceramic heater (9). An overheat protection sensor (14) measures the temperature of the radiator (8) that holds the ceramic heaters (9). If the radiator (8) reaches an unnecessarily high temperature, the overheat protection sensor (14) sends a message to the control module (13) to turn off the ceramic heater (9).

By way of additional explanation, when a cold, wet winter season occurs, the headlamp outer lens cover (10) may get covered by snow, frost, or ice (12) that prevents the light from passing through, causing drivers to suffer from insufficient night drive illumination. When the driver commands the lens heater function to be activated, a first ambient sensor (16) located outside the headlight housing (11) confirms whether the lens heater function is reasonably needed. This prevents the lens heater system from being accidentally turned on during the warmer seasons when it is not needed. Upon confirmation, a goal sensor (15) detects the close proximity of the outer lens cover(10)'s inner surface area temperature to determine how much additional heating power is required to effectively break the adhesion of the snow, frost, or ice layer(12). Hence, it slides off and clears up from the headlight outer lens cover (10) to ensure undisturbed sufficient illumination can be achieved for the driver's safety.

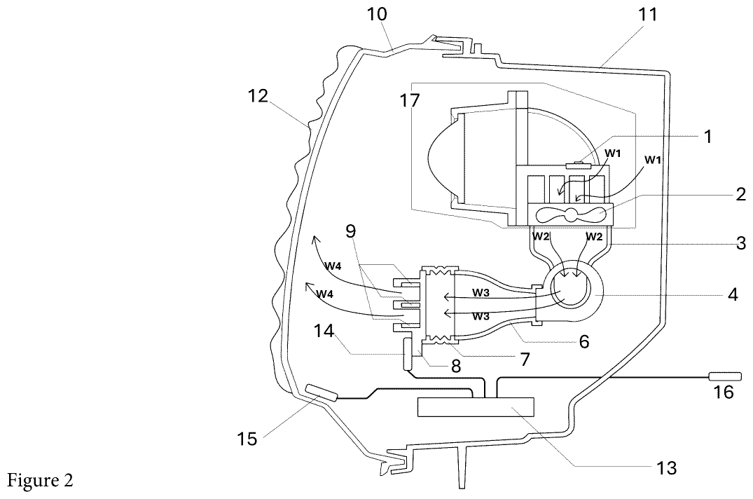

FIG. 2 is a side, cut-away view of a second embodiment of the invention. In a second embodiment, an exhaust heated air guide (3) funnels the waste heat (W2) from the main optic cooling fan (2). It directs it into the blower fan (4), which then has second air guide (6) funnel the air from the blower fan(4) through an air-tight joint duct (8) which ensures that all the waste heat (W1) from the main optic cooling fan(2) ends up being blown through the radiator (8) that holes ceramic heater (9) to fully utilize all available thermal energy. This is an effective solution when the main optics (17) is away from the blower fan (4), or when the blower fan (4) to radiator (8) distance is greater than ideal due to headlamp design limitations. The main optic's cooling fan(2) blows or pulls the cool air (W1) in between the heatsink fin that mounts the LEDs(1), which needs heat management. The passing air flow created by the cooling fan (2) exchanges to receive the waste heat from the LEDs(1) via the heatsink fin surface, which becomes warm heat exhaust(W2). An exhaust heated air guide (3) funnels the waste heat (W2) from the main optic cooling fan (2) and directs it into the blower fan (4)The blower fan(4) harvests the heat exhaust(W2) from the main optics and directs airflow(W3) and projects through flower fan(4) exhaust port into a second air guide (6), which funnels the air(W3) from the blower fan(4) through an air-tight joint duct (7) which ensures that all the waste heat (W1) from the main optic cooling fan(2) ends up being blown through the radiator (8) that holes ceramic heater (9) to create adequate total heat power combined hot air(W4). As mentioned previously, at certain outside temperatures, the heat from the LED is not sufficient to warm the outer surface of the light lens enough to break the adhesion of the snow or ice layer(12) that has accumulated on the outer surface of the front lens(10) of the light, which strongly disturbs the headlight performance. An ambient temperature sensor (16) that is located outside of the light housing (11) but electronically connected to a control module (13) inside the light, detects pre-configured low temperatures to determine whether to allow the control module to be activated. The goal sensor (15) that is located near the vehicle light's front lens inner surface monitors the heated air convection(W4) temperature to determine the required amount of additional heating power and sends calculated electrical energy to a series of ceramic heating elements (9) that are arrayed in front of individual spines of the radiator vent(8). The heat from the ceramic heater (9) is dissipated through a radiator (8) with spines. Initially harvested waste heat (W1) finally becomes hot air (W4) that has calculated sufficient heating power and is projected towards the lens(10) inner surface that is in front of the main optics(17). Hot air (W4) warms the target area of the lens adequately to clear/melt away snow or ice(12) that has accumulated. A goal monitor sensor (15) observes the hot air (w4) convection temperature, and when a certain calculated temperature is reached, it sends an electronic message to the control module (13) to turn off the ceramic heater (9). An overheat protection sensor (14) measures the temperature of the radiator (8) that holds the ceramic heaters (9), and if the radiator (8) reaches unnecessarily high temperature, the overheat protection sensor (14) sends a message to the control module (13) to turn off the ceramic heater (9).

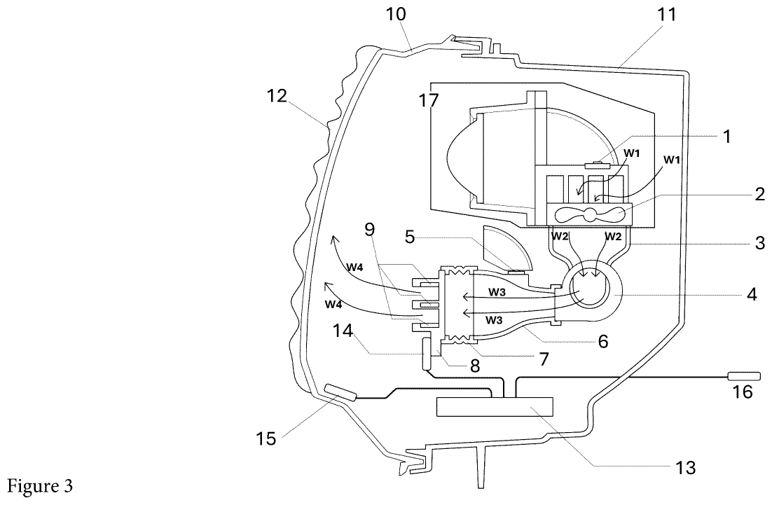

FIG. 3 is a side, cut-away view of a third embodiment of the invention. In a third embodiment, an exhaust heated air guide (3) funnels the waste heat (W2) from the main optic cooling fan (2) and directs it into the blower fan (4), which then has second air guide (6) that is made of high thermal conductive material such as aluminum, which holds secondary LED(5) for additional optics. Secondary LEDs (5) create additional heat that is available for lens heating and is dissipated in its heat into the air guide duct (6) via solid conduction, and the air guide duct (6) releases the second LED's (5) waste heat into passing warm air (W3) to add more heat power. Second air guide (6) funnels the air from the blower fan(4) through an air-tight joint duct (8), which ensures that all the waste heat (W1) from the main optic cooling fan(2) ends up being blown through the radiator (8) that holds the ceramic heater (9) to fully utilize all available thermal energy. This is an effective solution when the main optics (17) is away from the blower fan (4), or when the blower fan (4) to radiator (8) distance is greater than ideal, and when combined with an additional light source in the headlamp design. The main optic's cooling fan(2) blows or pulls the cool air (W1) in between the heatsink fin that mounts the LEDs(1), which needs heat management. The passing air flow created by the cooling fan (2) exchanges to receive the waste heat from the LEDs(1) via the heatsink fin surface, which becomes warm heat exhaust(W2). An exhaust heated air guide (3) funnels the waste heat (W2) from the main optic cooling fan (2) and directs it into the blower fan (4)The blower fan(4) harvests the heat exhaust(W2) from the main optics and directs airflow(W3) and projects through flower fan(4) exhaust port into a second air guide (6) that is made of high thermal conductive material such as aluminum, which holds secondary LED(5) for additional optics. Secondary LEDs (5) create additional heat that is available for lens heating and dissipates its heat into the air guide duct (6) via solid conduction, and the air guide duct (6) releases the second LED's (5) waste heat into the passing warm air (W3) to add more heat power. The second air guide duct (6) funnels the air(W3) from the blower fan(4) through an air-tight joint duct (7) which ensures that all the waste heat (W1) from the main optic cooling fan(2) ends up being blown through the radiator (8) that holes ceramic heater (9) to create adequate total heat power combined hot air(W4). As mentioned previously, at certain outside temperatures, the heat from the LED is not sufficient to warm the outer surface of the light lens enough to break the adhesion of the snow or ice layer(12) that has accumulated on the outer surface of the front lens(10) of the light, which strongly disturbs the headlight performance. An ambient temperature sensor (16) that is located outside of the light housing (11) but electronically connected to a control module (13) inside the light, detects pre-configured low temperatures to determine whether to allow the control module to be activated. The goal sensor (15) that is located near the vehicle light's front lens inner surface monitors the heated air convection(W4) temperature to determine the required amount of additional heating power and sends calculated electrical energy to a series of ceramic heating elements (9) that are arrayed in front of individual spines of the radiator vent(8). The heat from the ceramic heater (9) is dissipated through a radiator (8) with spines. Initially harvested waste heat (W1) finally becomes hot air (W4) that has calculated sufficient heating power and is projected towards the lens(10) inner surface that is in front of the main optics(17). Hot air (W4) warms the target area of the lens adequately to clear/melt away snow or ice(12) that has accumulated. A goal monitor sensor (15) observes the hot air (w4) convection temperature, and when a certain calculated temperature is reached, it sends an electronic message to the control module (13) to turn off the ceramic heater (9). An overheat protection sensor (14) measures the temperature of the radiator (8) that holds the ceramic heaters (9), and if the radiator (8) reaches unnecessarily high temperature, the overheat protection sensor (14) sends a message to the control module (13) to turn off the ceramic heater (9).

Each of the additional figures and methods disclosed herein can be used separately or in conjunction with other features and methods to provide improved devices and methods for making and using the same. Therefore, combinations of features and methods disclosed herein may not be necessary to practice the disclosure in its broadest sense and are instead disclosed merely to particularly describe representative and preferred embodiments.

Various modifications to the embodiments may be apparent to one of skill in the art upon reading this disclosure. For example, persons of ordinary skill in the relevant arts will recognize that the various features described for the different embodiments can be suitably combined, uncombined, and recombined with other features, alone, or in different combinations. Likewise, the various features described above should all be regarded as example embodiments, rather than limitations to the scope or spirit of the disclosure.

Persons of ordinary skill in the relevant arts will recognize that various embodiments can comprise fewer features than illustrated in any individual embodiment described above. The embodiments described herein are not meant to be an exhaustive presentation of the ways in which the various features may be combined. Accordingly, the embodiments are not mutually exclusive combinations of features; rather, the claims can comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

Unless indicated otherwise, references to “embodiment(s)”, “disclosure”, “present disclosure”, “embodiment(s) of the disclosure”, “disclosed embodiment(s)”, and the like contained herein refer to the specification (text, including the claims, and figures) of this patent application that are not admitted prior art.

For purposes of interpreting the claims, it is expressly intended that the provisions of 35 U.S.C. 112(f) are not to be invoked unless the specific terms “means for” or “step for” are recited in the respective claim.

It should be understood that while the preferred embodiments of the invention are described in some detail herein, the present disclosure is made by way of example only, and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records, but otherwise, all other copyright rights whatsoever are reserved.

What I claim is:

1. A vehicle light, consisting of a headlamp front lens and a headlight housing, a blower fan, a radiator, a ceramic heater, a goal monitor sensor, an overheat protection sensor, and ambient temperature sensor, a main optics, a control module, a cooling fan and an LED, wherein the headlamp front lens and the headlight housing are connected together to form an inside section, wherein the blower fan, the radiator, the ceramic heater, the goal monitor sensor, the overheat protection sensor, the main optics, the control module, the cooling fan and the LED are located in the inside section, and wherein the ambient temperature sensor is located outside of the inside section, and electronically connected to a control module, wherein the ambient temperature sensor is set to send a trigger to the control module with a certain outside temperature is detected, and wherein when the control panel is triggered by the ambient temperature sensor.

2. The vehicle light of claim 1, where the temperature sensor senses an internal temperature within the vehicle light, where when the temperature senor detects the internal temperature below a set point, it directs an amount of electricity to the one or more blower motors and the one or more heating elements, wherein the one or more blower motors turn on and direct a quantity of unheated air to the one or more heating elements, where the one or more heating elements heat up and provide a quantity of heat to the quantity of unheated air, where the quantify of unheated air becomes a quantity of heated air, where the quantity of heated air is directed to an interior surface of the front by a radiator vent.

3. The vehicle light of claim 2, where the one or more heating elements are ceramic heating elements.

4. The vehicle light of claim 3, where there are two blower motors.

5. The vehicle light of claim 4, where each radiator vent comprises at least two spines.

6. The vehicle light of claim 5, where each of the one or more heating elements is located in front of the at least two spines.

7. The vehicle light of claim 6, where the quantity of heated air is directed toward an inside surface of a front surface of the vehicle light.

8. The vehicle light of claim 7, where the number of spines is at least six.

9. A vehicle light, comprising, a front and a back, where the front and the back are connected together, a temperature sensor, one or more blower motors, one or more heating elements, and a radiator vent, where the temperature sensor senses an internal temperature within the vehicle light, where when the temperature senor detects the internal temperature below a set point, it directs an amount of electricity to the one or more blower motors and the one or more heating elements, wherein the one or more blower motors turn on and direct a quantity of unheated air to the one or more heating elements, where the one or more heating elements heat up and provide a quantity of heat to the quantity of unheated air, where the quantify of unheated air becomes a quantity of heated air, where the quantity of heated air is directed to an interior surface of the front by a radiator vent.

10. The vehicle light of claim 9, where the one or more heating elements are acrylic heating elements.

11. The vehicle light of claim 9, where the one or more heating elements are ceramic heating elements.

12. The vehicle light of claim 11, where there are two blower motors.

13. The vehicle light of claim 12, where each radiator vent comprises at least two spines.

14. The vehicle light of claim 13, where each of the one or more heating elements is located in front of the at least two spines.

15. The vehicle light of claim 14, where the quantity of heated air is directed toward an inside surface of a front surface of the vehicle light.

16. The vehicle light of claim 15, where the number of spines is at least six.
